(19) United States
(12) Patent Application Publication
(10) Pub. No.: US 2002/0113382 A1
(43) Pub. Date: Aug. 22, 2002

(54) Suspension system for loading an automotive vehicle

(76) Inventor: James Michael Dosdall, Grosse lle, MI (US)

Correspondence Address: Kevin G. Mierzwa, Artz & Artz PLC, Suite 250, 28333 Telegraph Road, Southfield, MI, 48034, US

(21) Appl. No.: 09/790,049

(22) Filed: Feb. 21, 2001

(51) Int. Cl. B60P 1/00

(52) U.S. Cl. 280/6.151

(57) ABSTRACT

An automotive vehicle (10) has a load bed (24) and a passenger compartment (22). The automotive vehicle (10) sits upon a road surface (20). A closure panel (26) is positioned at the end of load bed (24). A movement actuator (36) is coupled to the load bed (24) and positions the load bed (24) in a first position substantially parallel to the road surface so that the loading edge (28) is a first distance from the road surface and in a second position having an angle relative to the road surface (20) so that the edge is a second distance from the road surface. The second distance is less than the first distance. The closure panel (26) in the open position extends between the rear edge and the road surface to form a ramp therebetween to facilitate loading of cargo into load bed (24).

### TECHNICAL FIELD

The present invention relates generally to suspensions for automotive vehicles, and more particularly, to suspensions for automotive vehicles that allow at least a portion of the suspension to lower to facilitate loading.

### BACKGROUND OF THE INVENTION

Automotive vehicles, and in particular, pickup trucks, are typically used to haul various cargo. At times, the height of the cargo floor or load bed is high enough to prevent easy loading and unloading of the various cargos.

Known solutions for increasing the utility of utility vehicles include completely lowering the bed and maintaining the bed in a horizontal position with the road. However, due to rear axle position and drive line location, such a vehicle is often difficult to accomplish. Other known vehicles have extremely complex mechanical systems which intrude into the cargo space and flat load floor and thus are undesirable. Also, such systems fall short of lowering completely to the road surface so that an undesirable step into the loading floor is formed.

It would, therefore, be desirable to provide an automotive vehicle that allows easy loading and unloading without compromising the cargo load floor.

### SUMMARY OF THE INVENTION

In one aspect of the invention, an automotive vehicle that is used for traveling on a road surface includes a load bed that is compliantly suspended a distance above the road surface to accommodate travel over anticipated irregularities in surface. A movement actuator is coupled to the load bed and positions the load bed in an elevated position for travel and in a lowered position for loading. A closure panel is moveably coupled to the loading edge of the load bed and has a closed position and an open position. The closure panel in the open position extends between the loading edge of the load bed and the road surface to form a ramp therebetween.

One feature of the invention is that the ramp may be used to load the load bed with wheeled devices, including persons in wheelchairs who may proceed through the load bed into the driver's position in the passenger compartment.

Another feature of the invention is that special purpose modules, e.g. a dump box, pre-loaded cargo pallets, or a seating module for extended passenger carrying capability, may be easily drawn into the load bed from ground level without auxiliary lifting equipment.

Another feature of the invention is that the rear wheels could be individually serviced by lifting them one at a time with the movement actuator typically used for lowering the load floor. A “rocker jack” function may be implemented by equipping the vehicle with pivot point struts that allow the vehicle to lift its front wheels for servicing if both the load bed suspension actuators are simultaneously in a lowered position.

One advantage of the invention is that the teachings of the present invention may be applied to various types of vehicles including front wheel drive, rear wheel drive, and all wheel drive.

Other objects and features of the present invention will become apparent when viewed in light of the detailed description of the preferred embodiment when taken in conjunction with the attached drawings and appended claims.

### BRIEF DESCRIPTION OF THE DRAWINGS

FIGS. 1A and 1B are side views of an automotive vehicle having a suspension according to the present invention respectively in its traveling and loading positions.

FIGS. 2A and 2B are respective traveling and loading positions of the suspension according to the present invention.

FIG. 3 is a plan view of a first embodiment of a suspension according to the present invention.

FIG. 4 is a plan view of a second embodiment of a suspension according to the present invention.

FIG. 5 is a side view of an automotive vehicle having a rocker jack according to the present invention.

FIG. 6 is a side view of a modular passenger compartment that may be employed according to the present invention.

### DETAILED DESCRIPTION OF THE PREFERRED EMBODIMENT(S)

In the following figures, the same reference numerals are used to refer to the same components. The general principle as taught herein may be applied to front wheel, rear wheel or all wheel drive vehicles.

An automotive vehicle 10 has front wheels 12 having tires 14 disposed thereon and rear wheels 16 having tires 18 disposed thereon. Normally, the front tires 14 and rear tires 18 contact a road surface 20 for traveling therealong.

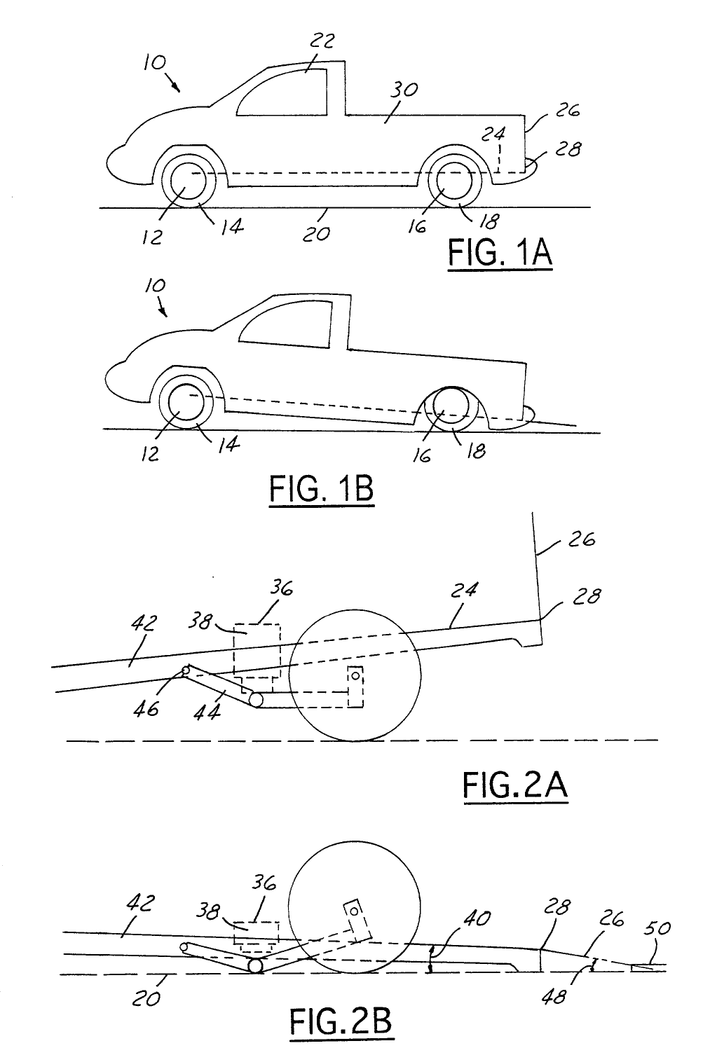

Referring now to FIGS. 1A and 1B, automotive vehicle 10 has a passenger compartment 22 and a load bed 24 which are coupled to frame rails 42. The automotive vehicle 10 also has a closure panel 26, which is moveably coupled to an edge 28 of the load bed. The edge 28 is illustrated as a rear edge but, these skilled in the art will recognize that the edge 28 may be a side edge. Load bed 24 may also include partial side walls 30 that may partially enclose load bed 24 so various cargo may be maintained therein.

As shown best in FIG. 1B, the closure panel 26, when vehicle 10 is in the loading position, may be used as a ramp to assist in loading.

Referring now to FIGS. 2A and 2B, a movement actuator 36, which may include an airspring 38, is coupled to move load floor 24 from a an elevated position for travel to a lowered position for loading, as illustrated in FIG. 2B. Air spring 38 may be positioned between frame 42 and a trailing arm 44 which pivots around a mount 46 on frame 42. As those skilled in the art will recognize, in the raising and lowering motion frame 42 pivots about the front wheel 12, and load floor 24 may be lower than a conventional axle between rear wheels 16 may permit.

As is illustrated, closure panel 26 may form a second angle 48 with road surface 20 or another surface 50, such as a curb. The angle 48 may be greater than or less than the angle 40 of the load floor. That is, closure panel 26 may be more or less coplanar with load floor 24 when in the open position.

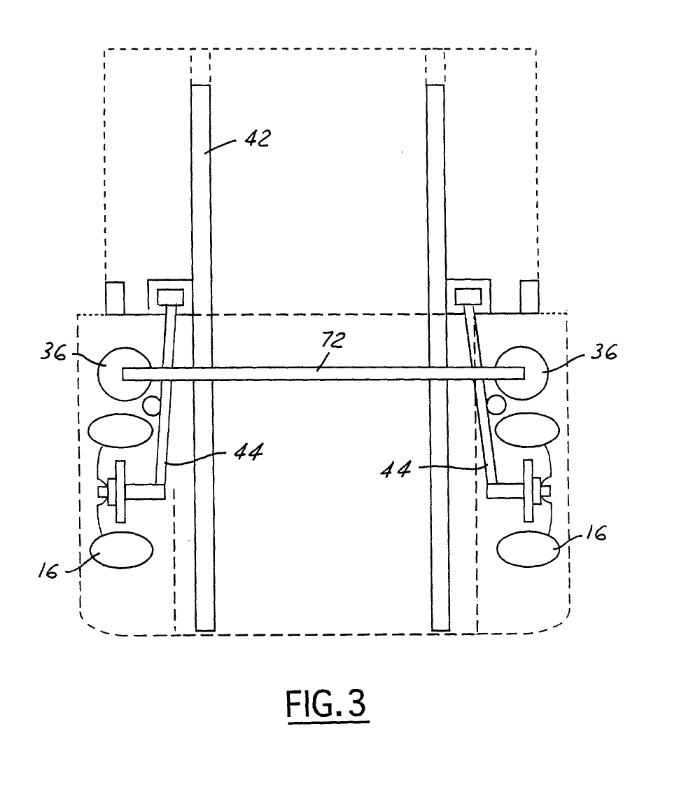

FIG. 3 is a plan view illustrating an embodiment for a front wheel drive vehicle. In this embodiment, a twist beam 72 joining trailing arms 44 has each of its ends coupled to a movement actuator 36 which may include an airspring 38. Trailing arms 44 are coupled to wheel assembly 16. Air spring 38 may also be coupled to an air compressor (not shown) in a conventional manner to allow the air spring 38 to be extended and retracted when desired, to level a loaded vehicle for travel, or to raise or lower rear edge 28 of load bed 24 to substantially ground level wherein closure panel 26 may extend to the ground and form a ramp for loading.

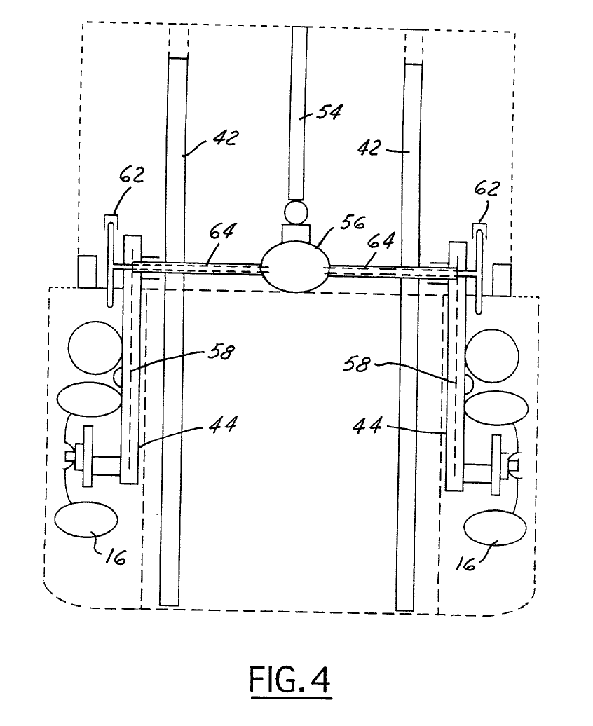

Referring now to FIG. 4, a second embodiment of a suspension for a rear wheel drive system is illustrated. A drive shaft 54 that is coupled to a transmission (not shown) is coupled to a differential 56. Because it is desirable to drop the load bed lower than a typical axle would permit, differential 56 is located more forward in the vehicle than in a typical vehicle. The angle 40 of the load bed 24 to the road surface 20 allows more room for differential 56 as it is located farther forward from edge 28 when it is lowered as close as practicable to ground level. Power is conveyed to wheel assembly 16 through a chain drive 58 which may be housed within structural trailing arms 44. These suspension arms pivot about a point on frame 42 at or near the axis of axle 64. This arrangement also provides an opportunity to reduce the unsprung mass of wheel assembly 16 by locating brake assemblies 62 on axle 64 rather than in wheel assembly 16.

Air springs and air control have been described in the previous figures. However, other types of movement actuators 36 such as hydraulic, pneumatic, electric, screw, worm, gear, differential chain or cable actuators may be used. It should also be noted that any of these actuators may also be used in conjunction with suspension springs such as a leaf springs, coil springs, or torsion bars. The displacer may be positioned between the suspension spring and the chassis or between the suspension spring and the wheel.

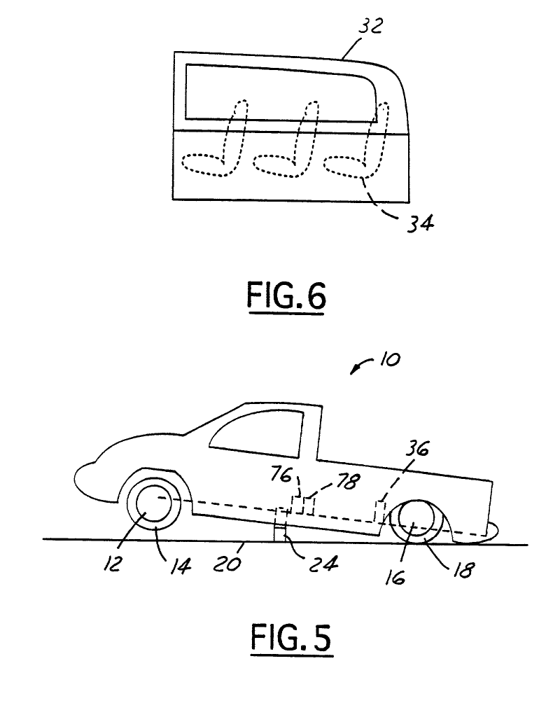

Referring now to FIG. 5, a rear tire pressure adjuster 78 may also be implemented. Rear tire pressure adjuster 78 may be controlled from within the passenger compartment 22 to deflate and inflate rear tires 18. By deflating rear tires 18, load bed 24 and thus rear edge 28 becomes closer to road surface 20.

In operation, the various movement actuators 38 may be used to angle load bed 24 relative to road surface 20. This will allow cargo to be easily loaded and unloaded from the vehicle 10.

Automotive vehicle 10 may also include a winch 76 that may be used to help draw various cargos or special purpose modules e.g. a dump box, pre-loaded cargo pallets, etc. into the load bed from ground level without auxiliary lifting equipment.

In FIG. 5, a rocker jack 74 may also be included in automotive vehicle 10. Rocker jack 74 extends from and retracts into automotive vehicle 10. Movement actuator 36 may be used to independently retract rear wheels 16 so that they may be serviced. When rocker jack 74 is extended, and both rear wheels 16 are retracted, front wheels and therefore front tires 14 are also off road surface 20 and can be serviced.

FIG. 6 illustrates a seating module 32 for extended passenger carrying capability. Seating module 32 may be permanently or removably attached to the load bed 24. Seating module 32 has a number of seats 34 positioned therein.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. An automotive vehicle for traveling on a road surface comprising:
a load bed having a loading edge;
a movement actuator coupled to said load bed and positioning said load bed in a first position substantially parallel to said road surface so that said loading edge is a first distance from the road surface and in a second position having a predetermined angle relative to said road surface so that said loading edge is a second distance from said road surface, said second distance being less than said first distance.

2. An automotive vehicle as recited in claim 1 further comprising a closure panel movably coupled to said edge of said load bed having a closed position and an open position; such that when said actuator is in the lowered position said closure panel in said open position extends between said edge and said road surface to form a ramp therebetween.

3. An automotive vehicle as recited in claim 1 further comprising interchangeable load modules sized to be received on said load bed.

4. An automotive vehicle as recited in claim 1 further comprising a winch coupled to said load bed for positioning a load thereon.

5. An automotive vehicle as recited in claim 1 further comprising a rocker jack coupled to said vehicle for supporting a front portion of said load bed, said rocker jack pivoting said vehicle in a rearward direction when said movement actuator simultaneously retracts said rear wheels and pivoting said vehicle in a forward direction so that said movement actuator may independently lift said rear wheels.

6. An automotive vehicle as recited in claim 1 wherein said movement actuator comprises a pair of trailing arms, a twist beam coupled between said trailing arms, said twist beam having a first end and a second end coupled to a respective first airspring and a second airspring.

7. An automotive vehicle as recited in claim 1 wherein said movement actuator comprises a first trailing arm and a second trailing arm, said first trailing arm and said second trailing arm coupled to a respective wheel assembly.

8. An automotive vehicle as recited in claim 1 further comprising a differential coupled to a power source, said differential coupled to said wheel assemblies through respective drive axles and drive chains.

9. An automotive vehicle as recited in claim 8 wherein said first drive chain and said second drive chain is disposed at least partially within said first trailing arm and second trailing arm.

10. An automotive vehicle as recited in claim 8 further comprising brake assemblies coupled to said drive axles.

11. An automotive vehicle for traveling on a road surface, said automotive vehicle having a pair of front wheels with front tires positioned thereon and a pair of rear wheels with a pair of rear tires positioned thereon, said movement actuator positioned thereon, said automotive vehicle comprising:
a passenger compartment;
a load bed having a rear edge;
frame rails extending under said passenger compartment and said load bed; and
a movement actuator coupled to said load bed and positioning said load bed in a first position substantially parallel to said road surface so that said rear edge is a first distance from the road surface and in a second position having a predetermined angle relative to said road surface so that said rear edge is a second distance from said road surface, said second distance being less than said first distance.

12. An automotive vehicle as recited in claim 11 further comprising a rocker jack coupled to said vehicle for lifting a front portion of said load bed, said rocker jack pivoting said vehicle in a rearward direction when said movement actuator simultaneously retracts said rear wheels and pivoting said vehicle in a forward direction so that said movement actuator may independently lift said rear wheels.

13. An automotive vehicle as recited in claim 11 further comprising a rear tire pressure adjuster, said rear tire pressure adjuster inflating and deflating said rear tires.

14. An automotive vehicle as recited in claim 11 further comprising a winch coupled to said load bed for positioning a load thereon.

15. An automotive vehicle as recited in claim 11 wherein said vehicle has a rear differential positioned adjacent to said passenger compartment.

16. An automotive vehicle as recited in claim 11 wherein said movement actuator comprises a pair of trailing arms pivotally coupled to said passenger compartment, a twist beam coupled between said trailing arms, said twist beam having a first end and a second end coupled to a respective first airspring and a second airspring.

17. An automotive vehicle as recited in claim 11 wherein said movement actuator comprises a first trailing arm and a second trailing arm, said first trailing arm and said second trailing arm coupled to a respective wheel assembly.

18. An automotive vehicle as recited in claim 11 further comprising a differential coupled to a sub-frame, said differential coupled to said wheel assembly through a respective first drive chain and a second drive chain.

19. An automotive vehicle as recited in claim 11 wherein said first drive chain and said second drive chain is disposed at least partially within said first trailing arm and second training arm.

20. An automotive vehicle as recited in claim 11 further comprising a disc brake assembly coupled to said first drive chain.

21. An automotive vehicle as recited in claim 11 further comprising a closure panel movably coupled to said rear edge of said load bed having a closed position and an open position, said closure panel in said open position extending between said rear edge and said road surface to form a ramp therebetween.
